(19) United States
(12) Patent Application Publication
(10) Pub. No.: US 2020/0161705 A1
(43) Pub. Date: May 21, 2020

(54) ELECTROLYTE INCLUDING AN ADDITIVE, AND LITHIUM SECONDARY BATTERY INCLUDING THE ELECTROLYTE

(71) Applicants: Samsung Electronics Co., Ltd., Suwon-si (KR); Samsung SDI Co., Ltd., Yongin-si (KR)

(72) Inventors: Jinah Seo, Seoul (KR); Myongchun KOH, Hwaseong-si (KR); Insun Park, Suwon-si (KR); Jihyun Jang, Yongin-si (KR)

(21) Appl. No.: 16/683,325

(22) Filed: Nov. 14, 2019

(30) Foreign Application Priority Data
Nov. 15, 2018 (KR) 10-2018-0141131

(51) Int. Cl. H01M 10/0567; H01M 4/131; H01M 4/133; H01M 4/134; H01M 4/36; H01M 4/505; H01M 4/525; H01M 4/38; H01M 4/587; H01M 4/62; H01M 10/0525; H01M 10/0569

(52) U.S. Cl. CPC H01M 10/0567; H01M 4/131; H01M 4/133; H01M 4/134; H01M 4/364; H01M 4/505; H01M 2300/004; H01M 4/386; H01M 4/587; H01M 4/628; H01M 10/0525; H01M 10/0569; H01M 2300/0034; H01M 4/525

(57) ABSTRACT

An electrolyte including: a lithium salt; an organic solvent; a sulfone compound represented by Formula 1; and a phosphate compound represented by Formula 2

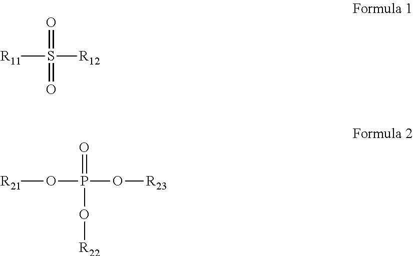

wherein definitions of R₁₁, R₁₂, R₂₁, R₂₂, and R₂₃ in Formulae 1 and 2 are provided in the detailed description of the present disclosure.

### CROSS-REFERENCE TO RELATED APPLICATION

This application claims priority to and the benefit of Korean Patent Application No. 10-2018-0141131, filed on Nov. 15, 2018, in the Korean Intellectual Property Office, and all the benefits accruing therefrom under 35 U.S.C. § 119, the content of which is incorporated herein in its entirety by reference.

### BACKGROUND

### 1. Field

The present disclosure relates to an electrolyte including an additive, and a lithium secondary battery including the electrolyte.

### 2. Description of the Related Art

Lithium secondary batteries are used as power sources for driving portable electronic appliances such as video cameras, mobile phones, and notebook computers. Rechargeable lithium secondary batteries have three times greater specific energy than lead batteries, nickel-cadmium batteries, nickel metal hydride batteries, and nickel-zinc batteries, and may be charged at a high rate.

As cathode active materials included in cathodes of lithium secondary batteries, lithium-containing metal oxides are used. For example, a composite oxide of lithium and a metal selected from cobalt (Co), manganese (Mn), nickel (Ni), and a combination thereof may be used. Among these, high-Ni-content cathode active materials have recently been studied because they may provide a higher capacity battery as compared with lithium cobalt oxide.

However, in the case of a high-Ni-content cathode active material, the surface structure of a cathode is weak, which can result in an increase in resistance, poor lifetime characteristics, and a high amount of gas generation.

Therefore, there remains a need to develop a lithium secondary battery including a high-Ni-content cathode active material, which exhibits high capacity and low resistance, good lifetime characteristics, and good gas reduction characteristics, as well as other properties.

### SUMMARY

Provided is an electrolyte composition.

Provided is a lithium secondary battery including the electrolyte.

Additional aspects will be set forth in part in the description which follows and, in part, will be apparent from the description, or may be learned by practice of the presented embodiments.

According to an aspect of an embodiment, an electrolyte includes: a lithium salt; an organic solvent; a sulfone compound represented by Formula 1; and a phosphate compound represented by Formula 2

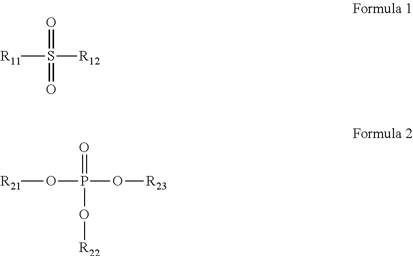

wherein in Formulae 1 and 2,

R₁₁ and R₁₂ are each independently hydrogen, deuterium, a hydroxyl group, a substituted or unsubstituted C₁-C₆ alkyl group, a substituted or unsubstituted C₂-C₆ alkenyl group, a substituted or unsubstituted C₂-C₆ alkynyl group, a substituted or unsubstituted C₆-C₁₀aryl group, or a substituted or unsubstituted C₁-C₁₀ heteroaryl group, and at least one of R₁₁ and R₁₂ includes at least one unsaturated bond, and if one of R₁₁ or R₁₂ groups includes a vinyl group the other group does not include a vinyl group, and

R₂₁, R₂₂, and R₂₃ are each independently a substituted or unsubstituted C₁-C₆ alkyl group, a substituted or unsubstituted C₂-C₆ alkenyl group, a substituted or unsubstituted C₂-C₆ alkynyl group, a substituted or unsubstituted C₆-C₁₀ aryl group, or a substituted or unsubstituted C₁-C₁₀ heteroaryl group.

According to an aspect of another embodiment, a lithium secondary battery includes: a cathode; an anode; and the electrolyte, wherein the cathode includes a cathode active material represented by Formula 3

LiₓNi_{y}M_{1-y}O_{2-z}A_{z} Formula 3

wherein in Formula 3,

0.9≤x≤1.2, 0.1≤y≤0.98, and 0≤z≤0.2 are satisfied, and

M is at least one of Al, Mg, Mn, Co, Fe, Cr, V, Ti, Cu, B, Ca, Zn, Zr, Nb, Mo, Sr, Sb, W, or Bi, and

A is an element having an oxidation number of −1, −2, or −3.

Also disclosed is a method of manufacturing an electrolyte, the method including: providing the lithium salt, the organic solvent, the sulfone compound of Formula 1 and the phosphate compound of Formula 2; and contacting the lithium salt, the organic solvent, the sulfone compound of Formula 1 and the phosphate compound of Formula 2 to manufacture the electrolyte.

Also disclosed is a method of manufacturing a lithium secondary battery, the method including: providing a positive electrode and a negative electrode; and disposing the electrolyte of claim 1 between the positive electrode and the negative electrode to manufacture the lithium secondary battery.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a lithium secondary battery according to an example embodiment;

FIG. 2 is a graph of phase (angle, θ) versus frequency (Hertz, Hz) and is a Bode plot illustrating the phase signals of lithium secondary batteries manufactured in Example 1 and Comparative Examples 1 and 2 with respect to frequency; and

FIG. 3 is a graph of differential capacity (dQ/dV, milliampere-hours per volt, mAh/V) versus voltage (volts) for lithium secondary batteries manufactured in Example 5 and Comparative Example 8 with respect to a battery voltage of a first cycle.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, “a,” “an,” “the,” and “at least one” are do not denote a limitation of quantity, and are intended to cover both the singular and plural, unless the context clearly indicates otherwise. For example, “an element” has the same meaning as “at least one element,” unless the context clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an electrolyte according to an example embodiment and a lithium secondary battery employing the electrolyte will be described in further detail.

An electrolyte according to an embodiment includes: a lithium salt; an organic solvent; a sulfone-based compound represented by Formula 1; and a phosphate-based compound represented by Formula 2.

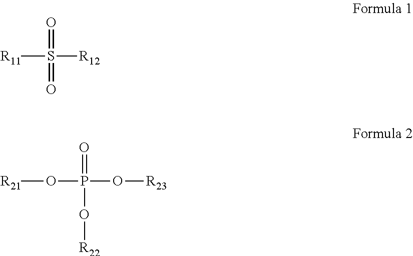

In Formulae 1 and 2, R₁₁ and R₁₂ are each independently hydrogen, deuterium, a hydroxyl group, a substituted or unsubstituted C₁-C₆ alkyl group, a substituted or unsubstituted C₂-C₆ alkenyl group, a substituted or unsubstituted C₂-C₆ alkynyl group, a substituted or unsubstituted C₆-C₁₀ aryl group, or a substituted or unsubstituted C₁-C₁₀ heteroaryl group; and at least one of R₁₁ or R₁₂ includes at least one unsaturated bond, and if one of R₁₁ or R₁₂ groups includes a vinyl group the other group does not include a vinyl group; and R₂₁, R₂₂, and R₂₃ are each independently a substituted or unsubstituted C₁-C₆ alkyl group, a substituted or unsubstituted C₂-C₆ alkenyl group, a substituted or unsubstituted C₂-C₆ alkynyl group, a substituted or unsubstituted C₆-C₁₀ aryl group, or a substituted or unsubstituted C₁-C₁₀ heteroaryl group.

As will be described further later, if a lithium metal composite oxide having a high-Ni-content is used as a cathode active material, in spite of providing high-capacity, deterioration of lifetime characteristics, such as a capacity retention and/or a resistance, increase rate can be significant, and a large amount of may be gas generated at high temperature, so that it is difficult to commercialize.

While not wanting to be bound by theory, it is understood that the deterioration of lifetime characteristics, such as the capacity retention and the resistance, is caused by an elution of Ni³⁺ cations from a cathode into an electrolyte, or from a disproportionation reaction as some of the Ni³⁺ cations are reduced to Ni²⁺ cations during battery discharge to produce NiO. Moreover, physical and chemical events can result in a deterioration in liftetime characteristics, and an increase in resistance. It has been unexpectedly observed that when the electrolyte includes the phosphate-based compound represented by Formula 2, elution of Ni³⁺ cations and the disproportionation reaction is reduced. Thus inclusion of the phosphate-based compound represented by Formula 2 in the electrolyte unexpectedly protects the cathode active material.

For example, and while not wanting to be bound by theory, it is understood that because the phosphate-based compound has a high affinity with Ni³⁺ cations though coordination of an unshared electron pair of oxygen atoms, the phosphate-based compound may suppress side reactions of Ni³⁺ cations. In particular, even when a battery is driven under a high voltage, the phosphate-based compound may maintain a high affinity with Ni³⁺ cations, and thus the phosphate-based compound may suppress the elution of Ni³⁺ cations, and the reduction of Ni³⁺ into Ni².

Further, since the phosphate-based compound has lower reactivity with oxygen, water, or the like than a phosphite-based compound, the phosphate-based compound may have high stability as compared with the phosphite-based compound. Accordingly, if an electrolyte including a phosphate-based compound is used, the storage stability, lifetime characteristics and resistance suppressing effect of a lithium secondary battery may be further improved compared to an electrolyte including a phosphite-based compound.

Further, and again while not wanting to be bound by theory, it is understood that gas generation at high temperature, e.g., about 30° C. to about 90° C., or 40° C. to about 80° C., is primarily caused by the decomposition of an SEI film on the surface of an anode by Ni³⁺ cations eluted from a cathode. Therefore, in order to overcome this phenomenon, the electrolyte includes a sulfone-based compound represented by Formula 1. While not wanting to be bound by theory, it is understood that because the sulfone-based compound represented by Formula 1 includes at least one unsaturated bond, the unsaturated bond may be reduced to form a strong sulfone-containing protective film on the surface of an anode. Thus, the generation of gas by the decomposition of a solvent may be suppressed.

As a result, the electrolyte may suppress gas generation at high temperature of a lithium secondary battery, and may improve the performance of a lithium secondary battery. Furthermore, as is further disclosed herein, use of the combination of the sulfone compound represented by Formula 1 and the phosphate compound represented by Formula 2 provide synergistic results not provided by the sulfone compound represented by Formula 1 and the phosphate compound represented by Formula 2 when used individually.

In an embodiment, R₁₁ and R₁₂ are each independently a methyl group, an ethyl group, a propyl group, an isopropyl group, a butyl group, a sec-butyl group, a tert-butyl group, an isobutyl group, a vinyl group, an allyl group, or a phenyl group; or a methyl group, an ethyl group, a propyl group, an isopropyl group, a butyl group, a sec-butyl group, a tert-butyl group, an isobutyl group, a vinyl group, an allyl group, or a phenyl group, each being substituted with at least one of deuterium, —F, —Cl, —Br, —I, a cyano group, a nitro group, a hydroxyl group, a methyl group, an ethyl group, or a propyl group.

In an embodiment, at least one of R₁₁ and R₁₂ is a vinyl group or an allyl group.

For example, the sulfone-based compound may be at least one of Compounds 101, 102, 103, 104, 105, 106, 107, 108, or 109:

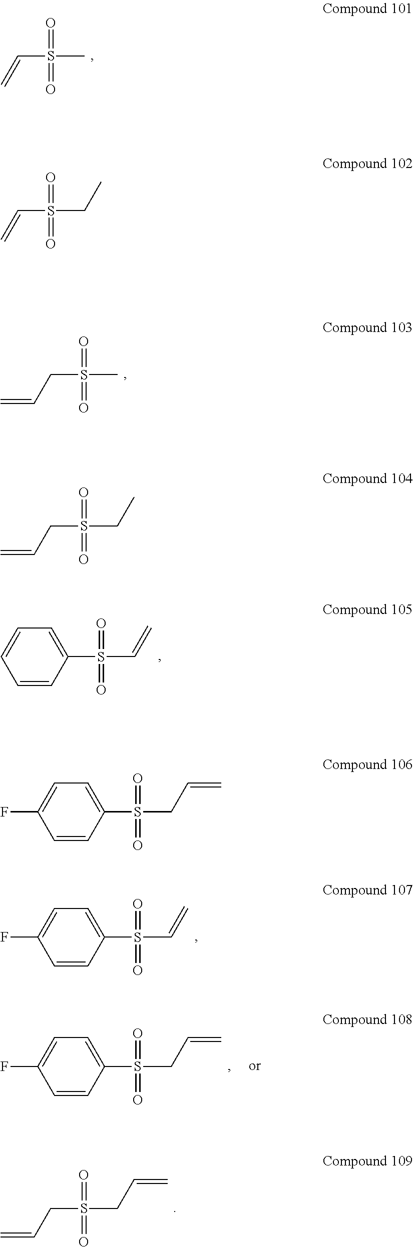

In an embodiment, R₂₁, R₂₂, and R₂₃ are each independently a methyl group, an ethyl group, a propyl group, an isopropyl group, a butyl group, a sec-butyl group, a tert-butyl group, an isobutyl group, or a phenyl group; or a methyl group, an ethyl group, a propyl group, an isopropyl group, a butyl group, a sec-butyl group, a tert-butyl group, an isobutyl group, or a phenyl group, each being substituted with at least one of deuterium, —F, —Cl, —Br, —I, a cyano group, a nitro group, a hydroxyl group, a methyl group, an ethyl group, or a propyl group.

For example, the phosphate compound may be at least one of Compounds 201, 201, 203, 204, 205, 206, 207, or 208:

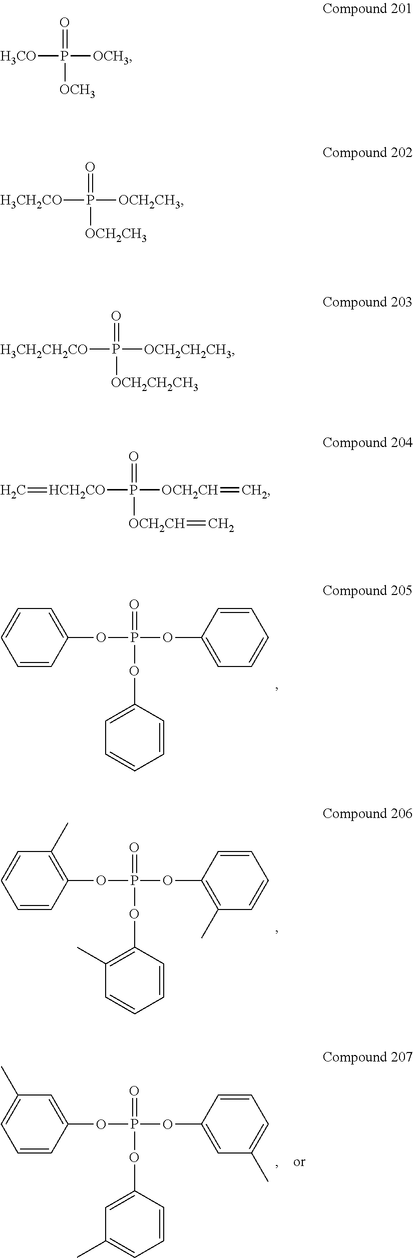

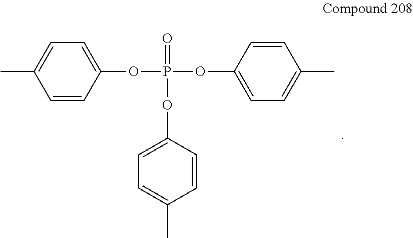

The sulfone-based compound may be included in the electrolyte in an amount of about 0.1 weight percent (wt %) to about 3 wt %, about 0.2 wt % to about 2.8 wt %, about 0.3 wt % to about 2.6 wt %, or about 0.4 wt % to about 2.4 wt %, based on the total weight of the electrolyte. However, the amount of the sulfone-based compound is not limited thereto, and may be used in any suitable amount in which a protective film may be formed on the surface of an anode. However, if the amount of the sulfone-based compound is more than about 3 wt %, a thick film can form on the surface of an anode, and lifetime characteristics of a lithium secondary battery may deteriorate, and discharge/charge cycle characteristics of a lithium secondary battery may deteriorate, for example, an initial resistance may increase, and a rate of resistance increase may increase. When the amount of the sulfone-based compound in the electrolyte is less than 0.1 wt %, the amount thereof may be too little to effectively form the protective film, and the effect of suppressing the gas generation at high-temperate may be insignificant.

For example, the sulfone-based compound may be included in an amount of about 0.1 wt % to about 2 wt % based on the total weight of the electrolyte. For example, the sulfone-based compound may be included in an amount of about 0.3 wt % to about 1 wt %, based on the total weight of the electrolyte.

The phosphate-based compound may be included in the electrolyte in an amount of about 0.1 wt % to about 5 wt %, about 0.2 wt % to about 4 wt %, or about 0.4 wt % to about 3 wt %, based on the total weight of the electrolyte. However, the amount of the phosphate-based compound is not limited thereto, and may be available in any amount range in which Ni³⁺ eluted from the cathode active material into the electrolyte may be stabilized. When the amount of the phosphate-based compound is more than about 5 wt %, initial resistance may be too large, which can lead to a decrease in battery capacity or storage stability, and a deterioration in discharge/charge cycle characteristics. When the amount of the phosphate-based compound is less than about 0.1 wt %, the amount thereof may be too little to sufficiently stabilize Ni³⁺, and thus it may be difficult to maintain a sufficient resistance decrease effect.

For example, the phosphate-based compound may be included in an amount of about 0.1 wt % to about 3 wt %, based on the total weight of the electrolyte. For example, the phosphate-based compound may be included in an amount of about 0.3 wt % to about 3 wt %, based on the total weight of the electrolyte. For example, the phosphate-based compound may be included in an amount of about 0.3 wt % to about 2 wt %, based on the total weight of the electrolyte.

In an embodiment, the organic solvent of the electrolyte may include a cyclic carbonate compound represented by Formula 21.

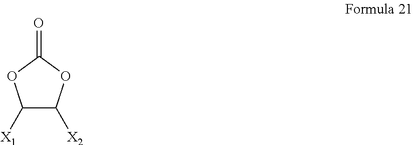

In Formula 21, X₁ and X₂ are each independently hydrogen or halogen, and at least one of X₁ and X₂ is F (a fluoro group).

For example, in the cyclic carbonate compound represented by Formula 21, X₁ may be hydrogen, and X₂ may be F. That is, the cyclic carbonate compound represented by Formula 21 may be fluoroethylene carbonate (FEC).

For example, the electrolyte may include the cyclic carbonate compound represented by Formula 21 in an amount of 10 volume percent (vol %) or less, based on the total volume of the organic solvent. For example, the electrolyte may include the cyclic carbonate compound represented by Formula 21 in an amount of about 0.1 vol % to about 10 vol %, 0.1 vol % to about 9 vol %, 0.1 vol % to about 8 vol %, 0.1 vol % to about 7 vol %, 0.1 vol % to about 6 vol %, or 0.1 vol % to about 5 vol %, based on the total volume of the organic solvent.

For example, the FEC may be included in the electrolyte when the anode of the lithium secondary battery includes a silicon-based compound, a carbon-based compound, or a composite of a silicon-based compound and a carbon-based compound as an anode active material.

For example, the electrolyte may include the FEC in an amount of 10 vol % or less based on the total volume of the organic solvent. For example, the electrolyte may include the FEC in an amount of about 0.1 vol % to about 10 vol %, 0.1 vol % to about 9 vol %, 0.1 vol % to about 8 vol %, 0.1 vol % to about 7 vol %, 0.1 vol % to about 6 vol %, or 0.1 vol % to about 5 vol %, based on the total volume of the organic solvent.

In the lithium secondary battery including a silicon-based compound, a carbon-based compound, or a composite of a silicon-based compound and a carbon-based compound as an anode active material, and while not wanting to be bound by theory, it is understood that due to volume expansion and contraction of silicon during charge and discharge, lifetime characteristics are deteriorated and gas is generated. As described above, when the FEC is included in the electrolyte within the above range, a passivation film, which can include a chemical reaction product of the above materials, e.g., an SEI film, may form on a surface of an anode or on the entire surface of the anode. Since the deterioration of the lifetime characteristics of the lithium secondary battery may be prevented by the SEI film, the stability and performance of the lithium secondary battery may be improved.

For example, the electrolyte may include at least one of the Compounds 101, 102, 103, 104, 105, 106, 107, 108, or 109 in an amount of about 0.1 wt % to about 3 wt %, about 0.2 wt % to about 2.5 wt %, or about 0.4 wt % to about 2 wt %, based on the total weight of the electrolyte and may include at least one of the Compounds 201 to 208 in an amount of about 0.1 wt % to about 5 wt %, about 0.2 wt % to about 4 wt %, about 0.4 wt % to about 3 wt %, based on the total weight of the electrolyte. Also, the organic solvent may include FEC in an amount of about 1 volume percent (vol %) to about 10 vol %, about 2 vol % to about 9 vol %, or about 3 vol % to about 8 vol %, based on the total volume of the organic solvent.

The lithium salt included in the electrolyte includes at least one of LiPF₆, LiBF₄, LiCF₃SO₃, Li(CF₃SO₂)₂N, LiC₂F₅SO₃, Li(FSO₂)₂N, LiC₄F₉SO₃, or LiN(SO₂CF₂CF₃)₂. The lithium salt included in the electrolyte may comprise or at least one compound represented by Formulae 22, 23, 25, or 25. The lithium salt included in the electrolyte may comprise at least one of LiPF₆, LiBF₄, LiCF₃SO₃, Li(CF₃SO₂)₂N, LiC₂F₅SO₃, Li(FSO₂)₂N, LiC₄F₉SO₃, or LiN(SO₂CF₂CF₃)₂, and at least one compound represented by Formulae 22, 23, 25, or 25.

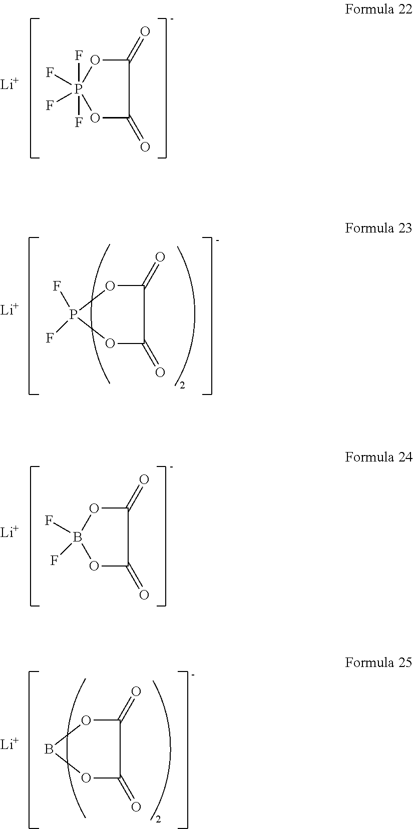

The concentration of the lithium salt may be about 0.01 moles per liter (M) to about 5.0 M, about 0.05 M to about 5.0 M, about 0.1 M to about 5.0 M, or about 0.1 M to about 2.0 M, but is not limited thereto. An appropriate concentration may be used as desired.

For example, the concentration of the lithium salt may be about 1.0 M to about 2.5 M. For example, the concentration of the lithium salt may be about 1.1 M to about 2.0 M. However, the concentration of the lithium salt is not limited to this range, and any suitable range in which the electrolyte is capable of effectively transferring lithium ions and/or electrons during a charge-discharging process may be available.

The organic solvent may be at least one of a carbonate-based solvent, an ester-based solvent, an ether-based solvent, or a ketone-based solvent.

As the carbonate-based solvent, ethyl methyl carbonate (EMC), methyl propyl carbonate (MPC), ethyl propyl carbonate (EPC), dimethyl carbonate (DMC), diethyl carbonate (DEC), dipropyl carbonate (DPC), propylene carbonate (PC), ethylene carbonate (EC), fluoroethylene carbonate (FEC), vinylene carbonate (VC), vinylethylene carbonate (VEC), or butylene carbonate (BC) may be used. As the ester-based solvent, methyl propionate, ethyl propionate, ethyl butyrate, methyl acetate, ethyl acetate, n-propyl acetate, dimethyl acetate, gamma butyrolactone, decanolide, gamma-valerolactone, mevalonolactone, or caprolactone may be used. As the ether-based solvent, dibutyl ether, tetraglyme, diglyme, dimethoxyethane, 2-methyltetrahydrofuran, or tetrahydrofuran may be used. As the ketone-based solvent, cyclohexanone may be used. As the nitrile-based solvent, acetonitrile (AN), succinonitrile (SN), or adiponitrile may be used. As other solvents, dimethylsulfoxide, dimethylformamide, dimethylacetamide, and tetrahydrofuran may be used, but not limited thereto, and any suitable solvent may be used as long as it may be used as an organic solvent in the art. A combination comprising at least one of the foregoing may be used.

For example, the organic solvent may include about 50 vol % to about 95 vol % of a chain carbonate and about 5 vol % to about 50 vol % of a cyclic carbonate, about 55 vol % to about 95 vol % of the chain carbonate and about 5 vol % to about 45 vol % of the cyclic carbonate, about 60 vol % to about 95 vol % of the chain carbonate and about 5 vol % to about 40 vol % of the cyclic carbonate, about 65 vol % to about 95 vol % of the chain carbonate and about 5 vol % to about 35 vol % of the cyclic carbonate, or about 70 vol % to about 95 vol % of the chain carbonate and about 5 vol % to about 30 vol % of the cyclic carbonate, based on the total volume of the electrolyte.

The organic solvent may be a mixed solvent of two or more, e.g., three types of organic solvents. For example, the organic solvent may be used alone, or may be used as a mixture of two or more.

For example, the organic solvent may include at least one of ethyl methyl carbonate (EMC), methyl propyl carbonate (MPC), ethyl propyl carbonate (EPC), dimethyl carbonate (DMC), diethyl carbonate (DEC), dipropyl carbonate (DPC), propylene carbonate (PC), ethylene carbonate (EC), fluoroethylene carbonate (FEC), vinylene carbonate (VC), vinylethylene carbonate (VEC), or butylene carbonate (BC).

A lithium secondary battery according to an embodiment includes: a cathode; an anode; and the aforementioned electrolyte, wherein the cathode includes a cathode active material represented by Formula 3.

LiₓNi_{y}M_{1-y}O_{2-z}A_{z} Formula 3

In Formula 3, 0.9≤x≤1.2, 0.1≤y≤0.98, and 0≤z<0.2 are satisfied, M is at least one of Al, Mg, Mn, Co, Fe, Cr, V, Ti, Cu, B, Ca, Zn, Zr, Nb, Mo, Sr, Sb, W, or Bi, and A is an element having an oxidation number of −1, −2, or −3. For example, in Formula 3, A may be a halogen, S, or N, but is not limited thereto. The halogen may be F, Cl, Br, or I.

For example, in Formula 3, y represents the amount of Ni in the cathode active material, and 0.7≤y≤0.98 may be satisfied. For example, in Formula 3, 0.8≤y≤0.98 may be satisfied. For example, in Formula 3, 0.88≤y≤0.94 may be satisfied.

When the amount of Ni in the cathode active material is less than 70%, the deterioration of the lifetime characteristics of the high-Ni-content cathode active material, from Ni³⁺ cation elution or disproportionation, for example, may be insignificant due to a stable surface structure of the cathode active material. When the amount of Ni in the cathode active material is less than about 70%, lifetime may decrease, e.g., due to resistance increase from the phosphate, having an affinity with Ni³⁺, forming a resistive layer on a surface of the cathode active material, and thus resistance increases.

For example, the cathode active material may be represented by Formula 4 below.

Li_{x′}Ni_{y′}Co_{1-y′-z′}Mn_{z′}O₂ Formula 4

In Formula 4, 0.9≤x′≤1.2, 0.8≤y′≤0.98, 0<z′<0.1, and 0<1−y′−z′<0.2 are satisfied. For example, in Formula 4, 0.88≤y′≤0.94 may be satisfied.

For example, the cathode may include at least one of LiNi_{0.88}Co_{0.08}Mn_{0.04}O₂, LiNi_{0.91}Co_{0.06}Mn_{0.03}O₂, Li_{1.02}Ni_{0.88}Co_{0.08}Mn_{0.04}O₂, or Li_{1.02}Ni_{0.91}Co_{0.06}Mn_{0.03}O₂ as the cathode active material.

As described above, in the case of a lithium metal composite oxide having a high-Ni-content, in spite of providing a high-capacity batteries, as the amount of Ni³⁺ cations increases, lifetime characteristics are poor, resistance is high, and the generation amount of a gas at high temperature increases. Accordingly, when the electrolyte includes the phosphate-based compound represented by Formula 2, Ni³⁺ cations are protected, thereby preventing the elution of Ni³⁺ cations and the disproportionation reaction. Further, as a configuration for preventing or reducing the gas generation at high-temperature, which is understood to be caused by the decomposing of an SEI film on the surface of the anode by the Ni³⁺ cations eluted from the cathode, the electrolyte includes the sulfone-based compound represented by Formula 1. Accordingly, a protective film containing sulfone is formed on the surface of the anode, so that the decomposition of the SEI film is suppressed, and thus gas generation is suppressed or minimized.

The cathode may further include at least one of lithium cobalt oxide, lithium nickel cobalt manganese oxide, lithium nickel cobalt aluminum oxide, lithium iron phosphorus oxide, and lithium manganese oxide, in addition to the aforementioned cathode active material. However, the present disclosure is not limited thereto, and the cathode may further include any suitable cathode active materials available in the art.

The anode includes an anode active material, and the anode active material may include at least one of a silicon-based compound, a carbon-based compound, a composite of a silicon-based compound and a carbon-based compound, or a silicon oxide, e.g., SiOₓ₁, 0<x1<2.

For example, the silicon-based compound may include a silicon particle, and the silicon particle may have an average particle diameter of about 10 nanometers (nm) to about 200 nm. For example, the anode active material may include a composite of a silicon particle having an average particle diameter of 200 nm or less, e.g., about 200 nm to about 20 nm, and a carbon-based compound. For example, the anode active material may include a composite of silicon particles having an average particle diameter of about 150 nm or less, about 150 nm to about 30 nm, and a carbon-based compound.

For example, the composite of a silicon-based compound and a carbon-based compound may be a composite having a structure in which a silicon nanoparticle is placed on a carbon-based compound, a composite in which silicon nanoparticle is included in the surface and inside of a carbon-based compound, or a composite in which silicon particles are coated with a carbon-based compound to be included in the carbon-based compound. The composite of a silicon-based compound and a carbon-based compound may be an active material obtained by dispersing silicon nanoparticles having an average particle diameter of 200 nm or less, e.g., about 200 nm to about 20 nm, in carbon-based compound particle, and then performing carbon coating, or an active material in which silicon (Si) particles are disposed on and in graphite. The composite of a silicon-based compound and a carbon-based compound may have an average secondary particle diameter of about 5 micrometers (μm) to about 20 μm, and the silicon nanoparticles may have an average particle diameter of 200 nm or less, 150 nm or less, 100 nm or less, 50 nm or less, 20 nm or less, or 10 nm or less. For example, the silicon nanoparticles may have an average particle diameter of about 200 nm to about 20 nm, or about 100 nm to about 150 nm.

The capacity retention of the lithium secondary battery after 300 charge-discharge cycles at 25° C. may be 70% or more, for example, 75% or more, e.g., about 70% to about 99.9%, or about 75% to about 99%. For example, when the anode active material of the lithium secondary battery is a carbon-silicon composite, the capacity retention rate of the lithium secondary battery after 300 charge-discharge cycles at 25° C. may be 75% or more.

The direct current internal resistance (DCIR) of the lithium secondary battery, after 200 charge-discharge cycles at 25° C., may increase at a rate of about 150% or less, e.g., about 1% to about 150%, about 2% to about 125%, about 4% to about 100%, or about 6% to about 75%, when comparing the direct current internal resistance at the 1^{st} and 200^{th} cycles. For example, when the anode active material of the lithium secondary battery is a carbon-silicon composite, the DCIR increase of the lithium secondary battery after 200 charge-discharge cycles at 25° C. may be about 140% or less, for example, about 130% or less.

The capacity retention of the lithium secondary battery after 200 charge-discharge cycles at 45° C. may be about 75% or more, for example, about 80% or more. For example, when the anode active material of the lithium secondary battery is a carbon-silicon composite, the capacity retention of the lithium secondary battery after 200 charge-discharge cycles at 45° C. may be about 80% or more, about 75% to about 99.9%, or about 80% to about 99%, when comparing the capacity of the 1^{st} and 200^{th} cycles.

The DCIR increase rate of the lithium secondary battery after 200 charge-discharge cycles at 45° C. may be 150% or less. For example, when the anode active material of the lithium secondary battery is a carbon-silicon composite, the DCIR increase rate of the lithium secondary battery after 200 charge-discharge cycles at 45° C. may be 140% or less, for example, 130% or less.

The cell energy density of the lithium secondary battery may be about 500 Watt-hours per liter (Wh/L) or more, for example, about 500 Wh/L to about 900 Wh/L, or about 550 Wh/L to about 850 Wh/L. The lithium secondary battery may provide high power and a high energy density of 500 Wh/L or more.

The lithium secondary battery is not limited in form, and includes a lithium ion battery, a lithium ion polymer battery, and a lithium sulfur battery.

The lithium secondary battery according to an embodiment may be manufactured by the following method, or any suitable method known to those of skill in the art.

First, a cathode is prepared.

For example, a cathode active material composition in which a cathode active material, a conductive agent, a binder, and a solvent are mixed is prepared. The cathode is prepared by coating a cathode current collector with the cathode active material composition. Alternatively, the cathode may be prepared by casting the cathode active material composition onto a separate support, separating a film from the support and then laminating the separated film on a metal current collector. The cathode is not limited to the above-described form, and may have a form other than the above-described form.

The cathode active material may include a lithium-containing metal oxide in addition to the cathode active material represented by Formula 3 above. As the lithium-containing metal oxide, for example, two or more kinds of composite oxides of lithium and at least one of cobalt, manganese, nickel, or combinations thereof may be used.

For example, the cathode active material may further include a compound represented by any of Formulae of LiₐA_{1-b}B′_{b}D₂(here, 0.90≤a≤1.8 and 0≤b≤0.5 are satisfied); LiₐE_{1-b}B′_{b}O_{2-c}D_{c} (here, 0.90≤a≤1.8, 0≤b≤0.5, and 0≤c≤0.05 are satisfied); LiE_{2-b}B′_{b}O_{4-c}D_{c} (here, 0≤b≤0.5 and 0≤c≤0.05 are satisfied); LiₐNi_{1-b-c}Co_{b}B′_{c}D_{α} (here, 0.90≤a≤1.8, 0≤b≤0.5, 0≤c≤0.05, and 0<α≤2 are satisfied); LiₐNi_{1-b-c}Co_{b}B′_{c}O_{2-α}F′_{α} (here, 0.90≤a≤1.8, 0≤b≤0.5, 0≤c≤0.05, and 0<α<2 are satisfied); LiₐNi_{1-b-c}Co_{b}B′_{c}O_{2-α}F′₂ (here, 0.90≤a≤1.8, 0≤b≤0.5, 0≤c≤0.05, and 0<α<2 are satisfied); LiₐNi_{1-b-c}Mn_{b}B′_{c}D_{α} (here, 0.90≤a≤1.8, 0≤b≤0.5, 0≤c≤0.05, and 0<α≤2 are satisfied); LiₐNi_{1-b-c}Mn_{b}B′_{c}O_{2-α}F′_{α} (here, 0.90≤a≤1.8, 0≤b≤0.5, 0≤c≤0.05, and 0<α<2 are satisfied); LiₐNi_{1-b-c}Mn_{b}B′_{c}O_{2-α}F′₂ (here, 0.90≤a≤1.8, 0≤b≤0.5, 0≤c≤0.05, and 0<α<2 are satisfied); LiₐNi_{b}E_{c}G_{d}O₂ (here, 0.90≤a≤1.8, 0≤b≤0.9, 0≤c≤0.5, and 0.001≤d≤0.1 are satisfied); LiₐNi_{b}Co_{c}Mn_{d}GeO₂ (here, 0.90≤a≤1.8, 0≤b≤0.9, 0≤c≤0.5, 0≤d≤0.5, and 0.001≤e≤0.1 are satisfied); LiₐNiG_{b}O₂ (here, 0.90≤a≤1.8 and 0.001≤b≤0.1 are satisfied); LiₐCoG_{b}O₂ (here, 0.90≤a≤1.8 and 0.001≤b≤0.1 are satisfied); LiₐMnG_{b}O₂ (here, 0.90≤a≤1.8 and 0.001≤b≤0.1 are satisfied); LiₐMn₂G_{b}O₄ (here, 0.90≤a≤1.8 and 0.001≤b≤0.1 are satisfied); QO₂; QS₂; LiQS₂; V₂O₅; LiV₂O₅; LiTO₂; LiNiVO₄; Li_{(3-f)}J₂(PO₄)₃(0≤f≤2); Li_{(3-f)}Fe₂(PO₄)₃(0≤f≤2); and LiFePO₄.

In Formulae above, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

For example, the compound may be LiCoO₂, LiMnₓO₂ₓ(x=1 or 2), LiNi₁₋ₓMnₓO₂ₓ(0<x<1), LiNi_{1-x-y}CoₓMn_{y}O₂ (0≤x≤0.5, 0≤y≤0.5, 1−x−y>0.5), or LiFePO₄.

Also, a compound having a coating layer on the surface of the compound may be used, or a mixture of the compound and a compound having a coating layer may be used. This coating layer may include a coating element compound of an oxide of a coating element, a hydroxide of a coating element, an oxyhydroxide of a coating element, an oxycarbonate of a coating element, or a hydroxycarbonate of a coating element. The compound constituting this coating layer may be amorphous or crystalline. As the coating element included in the coating layer, Mg, Al, Co, K, Na, Ca, Si, Ti, V, Sn, Ge, Ga, B, As, Zr, or a mixture thereof may be used. In the process of forming the coating layer, any suitable coating method may be used as long as this compound may be coated with such elements by a method that does not adversely affect the physical properties of the cathode active material (for example, spray coating, dipping or the like). This coating method will be understood by those skilled in the art, and further detailed description thereof will be omitted herein for clarity.

The conductive agent is not limited as long as it has suitable electrical conductivity without causing a chemical change in the battery, and examples thereof may include graphite such as natural graphite or artificial graphite; carbon black, acetylene black, ketjen black, channel black, furnace black, lamp black, or thermal black; a conductive fiber such as carbon fiber or a metal fiber; carbon fluoride; a metal powder such as aluminum powder or nickel powder; a conductive whiskers such as zinc oxide and potassium titanate; a conductive metal oxide such as titanium oxide; or a conductive agent such as a polyphenylene derivative. A combination comprising at least one of the foregoing may be used.

The amount of the conductive agent may be about 1 wt % to about 20 wt %, based on the total weight of the cathode active material composition.

The binder is a component that assists in binding of the active material and the conductive agent as well as the binding of the active material to the current collector. The binder may be added in an amount of about 1 wt % to about 30 wt %, based on the total weight of the cathode active material composition. Examples of the binder may include polyvinylidene fluoride (PVdF), polyvinylidene chloride, polybenzimidazole, polyimide, polyvinyl acetate, polyacrylonitrile, polyvinyl alcohol, carboxymethylcellulose (CMC), starch, hydroxypropylcellulose, regenerated cellulose, polyvinylpyrrolidone, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenylene sulfide, polyamideimide, polyetherimide, polyether sulfone, polyamide, polyacetal, polyphenylene oxide, polybutylene terephthalate, ethylene-propylene-diene terpolymer (EPDM), sulfonated EPDM, styrene butadiene rubber (SBR), or fluorine rubber, or a copolymer thereof.

As the solvent, N-methylpyrrolidone, acetone, water, or the like may be used, but not limited thereto, and any suitable solvent which may be available in the technical field may be used. The amount of the solvent is, for example, about 10 parts by weight to about 100 parts by weight, based on 100 parts by weight of the cathode active material. When the amount of the solvent is within the above range, it is easy to form an active material layer.

The amount of the cathode active material, the amount of the conductive agent, the amount of the binder, and the amount of the solvent may amounts used in the lithium secondary battery, details of which can be determined by one of skill in the art without undue experimentation. At least one of the conductive agent, the binder and the solvent may be omitted depending on the use and configuration of the lithium secondary battery, if desired.

For example, N-methylpyrrolidone (NMP) may be used as the solvent, a PVdF or PVdF copolymer may be used as the binder, and carbon black or acetylene black may be used as the conductive agent. For example, 94 wt % of the cathode active material, 3 wt % of the binder, and 3 wt % of the conductive agent were mixed in a powder state, each based on a total of the cathode active material, binder, and conductive agent, NMP is added such that solid content is 70 wt % to make a slurry, and then this slurry is coated, dried and rolled to manufacture the cathode.

The cathode current collector is generally made to have a thickness of about 3 micrometers (μm) to about 50 μm. This cathode current collector is not limited as long as it has suitable conductivity without causing a chemical change in the battery. For example, the cathode current collector may include stainless steel, aluminum, nickel, titanium, or fired carbon, or may include aluminum or stainless steel surface-treated with carbon, nickel, titanium or silver. The cathode current collector may form fine irregularities on its surface to increase the adhesive force of the cathode active material, and may various forms such as film, sheet, foil, net, porous body, foam, and nonwoven fabric.

The loading level of the produced cathode active material may be 30 milligrams per square centimeter (mg/cm²) or more, for example, 35 mg/cm² or more, and for example, 40 mg/cm² or more, or about 30 mg/cm² to about 200 mg/cm². The electrode density may be 3 grams per cubic centimeter (g/cc) or more, for example, 3.5 g/cc or more. For example, for high cell energy density, the loading level of the produced cathode active material may be about 35 mg/cm² to about 50 mg/cm², and the electrode density may be about 3.5 g/cc to about 4.2 g/cc or more. For example, both sides of the cathode plate may be coated with the cathode active material composition at a loading level of 37 mg/cm² and an electrode density of 3.6 g/cc.

When the loading level of the cathode active material and the electrode density satisfy the above ranges, a battery including this cathode active material may exhibit a high cell energy density of 500 Wh/L or more. For example, the battery may exhibit a cell energy density of about 500 Wh/L to about 900 Wh/L.

Next, an anode is prepared.

For example, an anode active material composition in which an anode active material, a conductive agent, a binder, and a solvent are mixed is prepared. The anode is prepared by applying, drying and pressing an anode active material on an anode current collector, and an anode active material composition, in which a binder is mixed with a solvent In addition to the above-described anode active material, is prepared as needed.

For example, the anode is prepared by directly coating an anode current collector with the anode active material composition and drying the anode active material composition. Alternatively, the anode may be prepared by casting the anode active material composition onto a separate support, separating a film from the support and then laminating the separated film on a metal current collector.

The anode active material may be, for example, a silicon-based compound, a carbon-based material, a silicon oxide (e.g., SiOₓ (0<x<2)), or a composite of a silicon-based compound and a carbon-based material. Here, the size (for example, average particle diameter) of silicon particles may be less than 200 nm, for example, about 10 nm to about 150 nm. The term “size” may refer to an average particle diameter when silicon particles are spherical, and may refer to an average long axis length when the silicon particles are non-spherical.

When the size of the silicon particles is within the above range, lifetime characteristics are suitable, and thus the lifetime of a lithium secondary battery is further improved when the electrolyte according to an embodiment is used.

The carbon-based material may be crystalline carbon, amorphous carbon, or a mixture thereof. The crystalline carbon may be graphite such as natural graphite or artificial graphite of an amorphous, plate-like, flake-like, spherical or fibrous form. The amorphous carbon may be soft carbon (low-temperature fired carbon), hard carbon, mesophase pitch carbide, or fired coke.

The composite of a silicon-based compound and a carbon-based material may be a composite having a structure in which silicon particles are arranged on graphite, or a composite having a structure in which silicon particles are included on the surface of graphite and inside graphite. The composite may be, for example, an active material in which silicon (Si) particles having an average particle diameter of 200 nm or less, for example, about 100 nm to about 200 nm, and for example, 150 nm are dispersed on graphite particles and then coated with carbon, or an active material in which silicon (Si) particles exist on graphite and inside graphite. Such a composite is available as the trade name SCN1 (Si particle on Graphite) or SCN2 (Si particle inside as well as on graphite). SCN1 may be an active material obtained by dispersing silicon (Si) particles having an average particle diameter of about 150 nm on graphite particles and then coating the dispersed silicon (Si) particles with carbon. SCN2 is an active material in which silicon (Si) particles having an average particle diameter of about 150 nm exist on graphite and inside graphite.

The anode active material may be used together with the above-described anode active material as long as it may be used as the anode active material of a lithium secondary battery in the related art. For example, the anode active material may be , Si, Sn, Al, Ge, Pb, Bi, Sb, a Si—Y′ alloy (Y′ is an alkali metal, alkaline earth metal, a Group 13 to Group 16 element, a transition metal, a transition metal oxide, a rare earth element, or combination thereof, not Si), or a Sn—Y′ alloy (Y′ is an alkali metal, an alkaline earth metal, a Group 13 to Group 16 element, a transition metal, a transition metal oxide, a rare earth element, or a combination thereof, not Sn). The element Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

For example, the anode active material may be lithium titanium oxide, vanadium oxide, or lithium vanadium oxide.

The conductive agent and binder in the anode active material composition may be the same as those in the cathode active material composition.

However, in the anode active material composition, water may be used as the solvent. For example, water may be used as the solvent, carboxymethyl cellulose (CMC), styrene butadiene rubber (SBR), an acrylate-based polymer, or a methacrylate-based polymer may be used as the binder, and carbon black, acetylene black, or graphite may be used as the conductive agent.

The amount of the anode active material, the amount of the conductive agent, the amount of the binder, and the amount of the solvent are amounts suitable for the lithium secondary battery. At least one of the conductive agent, the binder, and the solvent may be omitted depending on the use and configuration of the lithium secondary battery.

For example, 94 wt % of the anode active material, 3 wt % of the binder, and 3 wt % of the conductive agent were mixed in a powder state, based on a total weight of the anode active material, binder, and conductive agent, water is added such that solid content is 70 wt % to make a slurry, and then this slurry is coated, dried and rolled to manufacture an anode plate.

The anode current collector may be made to have a thickness of about 3 μm to about 50 μm. This anode current collector is not limited as long as it has suitable conductivity without causing an undesirable chemical change in the battery. For example, the anode current collector may include copper, stainless steel, aluminum, nickel, titanium, or fired carbon, may include copper or stainless steel surface-treated with carbon, nickel, titanium or silver, or may include an aluminum-cadmium alloy. Similarly to the cathode current collector, the anode current collector may have fine irregularities on its surface to increase the adhesive force of the anode active material, and may various forms such as film, sheet, foil, net, porous body, foam, and nonwoven fabric.

The loading level of the prepared anode active material composition is set according to the loading level of the cathode active material composition. The loading level of the anode active material composition may be 12 mg/cm² or more, for example, 15 mg/cm² or more, depending on the capacity of the anode active material composition per g. The electrode density may be 1.5 g/cc or more, for example, 1.6 g/cc or more. For example, for high cell energy density, the loading level of the prepared anode active material composition may be about 15 mg/cm² to about 25 mg/cm², and the electrode density may be about 1.6 g/cc to about 2.3 g/cc or more.

When the loading level of the anode active material and the electrode density satisfy the above ranges, a battery including this cathode active material may exhibit a high cell energy density of 500 Wh/L or more.

Next, a separator to be inserted between the anode and the cathode is prepared.

As the separator, any suitable separator may be used. A separator having low resistance to the movement of ions in the electrolyte and superior in electrolyte wettability may be used. For example, the separator may include at least one of glass fiber, polyester, Teflon, polyethylene, polypropylene, or polytetrafluoroethylene (PTFE), and may be made in the form of nonwoven fabric or woven fabric. For example, a windable separator including polyethylene, polypropylene, or the like may be used in a lithium ion battery, and a separator having good electrolyte impregnation ability may be used in a lithium ion polymer battery. For example, the separation film may be produced by the following method.

A polymer resin, a filler, and a solvent are mixed to prepare a separator composition. The separator composition is directly applied on an electrode and dried to form a separator. Further, the separator composition is cast on a support and dried, a separation film is separated from the support, and then the separation film is laminated on the electrode to form a separator.

The polymer resin used in the production of the separator is not limited, and any suitable material may be used as long as it may be used in a binder of an electrode plate. For example, as the polymer resin, a vinylidene fluoride/hexafluoropropylene copolymer, polyvinylidene fluoride (PVDF), polyacrylonitrile, polymethyl methacrylate, or a mixture thereof may be used.

Next, the above-described electrolyte is prepared.

According to an embodiment, in addition to the above-described electrolyte, a non-aqueous electrolyte, a solid electrolyte, an organic solid electrolyte, or an inorganic solid electrolyte may be used.

As the organic solid electrolyte, for example, a polyethylene derivative, a polyethylene oxide derivative, a polypropylene oxide derivative, a phosphate ester polymer, a polyester sulfide, a polyvinyl alcohol, a polyvinylidene fluoride, or a polymer including an ionic dissociation group may be used.

As the inorganic solid electrolyte, for example, Li₃N, LiI, Li₅NI₂, Li₃N—LiI—LiOH, LiSiO₄, Li₂SiS₃, Li₄SiO₄, Li₄SiO₄—LiI—LiOH, or Li₃PO₄—Li₂S—SiS₂ may be used. A combination comprising at least one of the foregoing may be used.

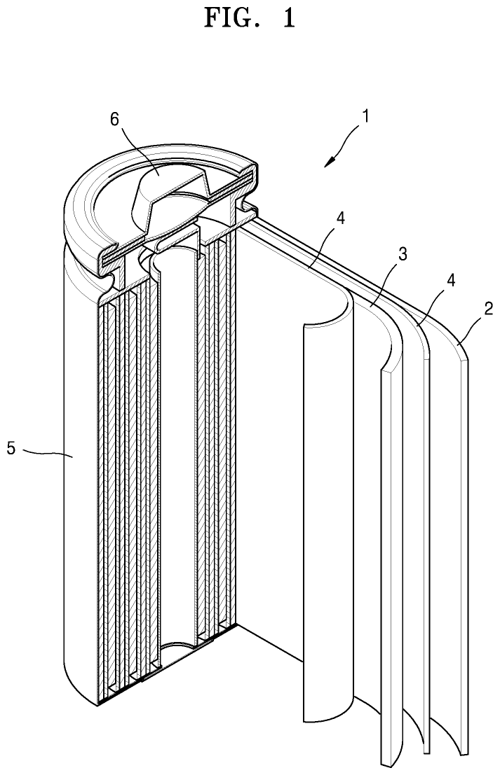

As shown in FIG. 1, the lithium secondary battery 1 includes a cathode 3, an anode 2, and a separator 4. The anode 3, the cathode 2, and the separator 4 are wound or folded and accommodated in a battery case 5. Then, an electrolyte is injected into the battery case 5, and the battery case 5 is sealed with a cap assembly 6 to complete the lithium secondary battery 1. The battery case 5 may have a cylindrical shape, a rectangular shape, or a thin film shape. For example, the lithium secondary battery 1 may be a large-sized thin-film battery. The lithium secondary battery 1 may be a lithium ion battery.

The separator may be located between the anode and the cathode to form a battery structure. The battery structure is laminated as a bi-cell structure and then impregnated with an electrolyte, and the resulting product is accommodated in a pouch and sealed to complete a lithium ion polymer battery.

Further, the plurality of battery structures may be laminated to form a battery pack, and this battery pack may be used in all appliances requiring high capacity and high power. For example, the battery pack may be used in notebooks, smart phones, electric vehicles, and the like.

The lithium secondary battery according to an embodiment significantly reduces a DCIR increase rate as compared with a lithium secondary battery with a general nickel-rich lithium-nickel composite oxide as a cathode active material, and thus may exhibit good battery characteristics.

The operating voltage of the lithium secondary battery to which the anode, the cathode and the electrolyte are applied is, for example, about 2.5 volts (V) to about 2.8 V as a lower limit and about 4.1 V to about 4.4 V as an upper limit, and energy density is 500 Wh/L or more.

Further, the lithium secondary battery may be used in, for example, power tools operated by a power from an electric motor; electric vehicles including a hybrid electric vehicle (HEV) and a plug-in hybrid electric vehicle (PHEV); electric motorcycles including an electric bike (E-bike) and an electric scooter (E-scooter); electric golf carts; or power storage systems, but the present disclosure is not limited thereto.

As used herein, alkyl refers to a saturated branched or unbranched (or linear or linear) monovalent hydrocarbon.

Non-limiting examples of “alkyl” may include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, or n-heptyl.

The alkyl group may be substituted or at least one hydrogen atom of may be substituted. The substituent may include a halogen atom, a halogen atom-substituted C₁-C₂₀ alkyl group (for example, CCF₃, CHCF₂, CH₂F, or CCl₃), a C₁-C₂₀ alkoxy group, an alkoxyalkyl group of C₂-C₂₀, a hydroxyl group (—OH), a nitro group (—NO₂), a cyano group (—CN), an amino group (—NH₂), an amidino group (—C(═NH)NH₂), a hydrazine group (—NHNH₂), a hydrazone group (═N—NH₂), a carboxyl group (—C(═O)OH) or a salt thereof (—C(═O)OM, wherein M is an organic or inorganic anion), a sulfonyl group (—SO₂H), a sulfamoyl group (—SO₂NH₂), a sulfonic acid group (—SO₃H₂) or a salt thereof (—SO₃MH or —SO₃M₂ wherein M is an organic or inorganic anion), phosphoric acid (—PO₃H₂) or a salt thereof (—PO₃MH or —PO₃M₂ wherein M is an organic or inorganic anion), a C₁-C₂₀ alkyl group, a C₂-C₂₀ alkenyl group, a C₂-C₂₀ alkynyl group, a C₁-C₂oheteroalkyl group, a C₆-C₂₀ aryl group, a C₆-C₂₀ arylalkyl group, a C₃-C₂₀ heteroaryl group, a C₃-C₂₀ heteroarylalkyl group, a C₆-C₂₀ heteroaryloxy group, or a C₆-C₂₀ heteroaryloxyalkyl group.

The term “halogen” includes fluorine, bromine, chlorine, and iodine.

The “alkoxy” denotes “alkyl-O—”, wherein alkyl is as described above. Examples of the alkoxy group may include a methoxy group, an ethoxy group, a 2-propoxy group, a butoxy group, a t-butoxy group, a pentyloxy group, or a hexyloxy group. At least one hydrogen atom of the alkoxy may be substituted with a substituent as described above.

The “alkenyl” refers to branched or unbranched, monovalent hydrocarbon having at least one carbon-carbon double bond. Non-limiting examples of the alkenyl group may include vinyl, allyl, butenyl, propenyl, or isobutenyl, and at least one hydrogen atom of the alkenyl may be substituted a substituent as described above.

The “alkynyl” refers to branched or unbranched monovalent hydrocarbon having at least one carbon-carbon triple bond. Non-limiting examples of the alkynyl may include ethynyl, butynyl, isobutynyl, or isopropynyl.

At least one hydrogen atom of the alkynyl may be substituted with a substituent as described above.

The term “aryl” refers to a hydrocarbon group having an aromatic ring, and includes monocyclic and polycyclic hydrocarbons wherein the additional ring(s) of the polycyclic hydrocarbon may be aromatic or nonaromatic (e.g., phenyl or napthyl). At least one hydrogen atom of the aryl group may be substituted with a substituent as described above.

The term “heteroaryl” means a monovalent carbocyclic ring group that includes one or more aromatic rings, in which at least one ring member (e.g., one, two or three ring members) is a heteroatom. In a C₃ to C₃₀ heteroaryl, the total number of ring carbon atoms ranges from 3 to 30, with remaining ring atoms being heteroatoms. Multiple rings, if present, may be pendent, spiro or fused. The heteroatom(s) are generally independently selected from nitrogen (N), oxygen (O), P (phosphorus), and sulfur (S).

Examples of the heteroaryl may include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, or 5-pyrimidin-2-yl.

The term “heteroaryl” includes a case where a heteroaromatic ring is selectively fused to at least one of an aryl group, a cycloaliphatic group, or a heterocyclic group.

“Heteroarylalkyl” means a heteroaryl group linked via an alkylene moiety. The specified number of carbon atoms (e.g., C3 to C30) means the total number of carbon atoms present in both the aryl and the alkylene moieties, with remaining ring atoms being heteroatoms as discussed above.

“Aryloxy” means an aryl moiety that is linked via an oxygen (i.e., —O-aryl). An aryloxy group includes a C6 to C30 aryloxy group, and specifically a C6 to C18 aryloxy group. Non-limiting examples include phenoxy, naphthyloxy, and tetrahydronaphthyloxy.

Hereinafter, the present disclosure will be described in more detail with reference to Examples and Comparative Examples. However, these Examples are for illustrating the present disclosure, and the scope of the present disclosure is not limited thereto.

### EXAMPLES

A list of chemical component abbreviations are listed for reference.

| | |
|---|---|
| AMS | Allyl methyl sulfone |
| TPPa | Triphenyl phosphate |
| FEC | Fluoroethylene carbonate |
| EC | Ethylene carbonate |
| EMC | Ethyl methyl carbonate |
| DMC | Dimethyl carbonate |
| DPhs | Diphenyl sulfone |
| EVS | Ethyl vinyl sulfone |
| PVdF | Polyvinylidene fluoride |

### Preparation of Electrolyte

### Preparation Example 1 Electrolyte: 1.15M LiPF₆, AMS 1 Wt %+TPPa 0.3 Wt %

1 weight percent (wt %) of Compound 103 and 0.3 wt % of Compound 205, based on the total weight of an electrolyte, were added to an organic solvent in which 3 vol % of FEC, based on the total volume of the organic solvent, was mixed with EC/EMC/DMC (volume ratio 10:47:40), and 1.15M LiPF₆ was used as a lithium salt to prepare an electrolyte.

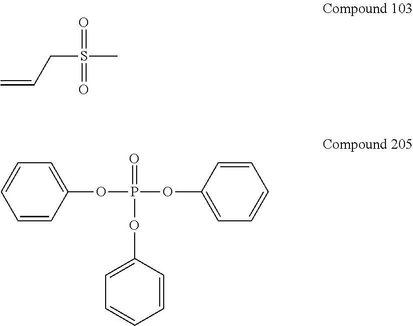

### Comparative Preparation Example 1: 1.15M LiPF₆, AMS+TPPa 0 Wt %

An electrolyte was prepared in the same manner as in Preparation Example 1, except that 1 wt % of Compound 103 and 0.3 wt % of Compound 205 were not added.

### Comparative Preparation Example 2: 1.15M LiPF₆, AMS 1 Wt %

An electrolyte was prepared in the same manner as in Preparation Example 1, except that 0.3 wt % of Compound 205 was not added.

### Comparative Preparation Example 3: 1.15M LiPF₆, DVSF 1 Wt %

An electrolyte was prepared in the same manner as in Preparation Example 1, except that 0.3 wt % of Compound 205 was not added, and 1 wt % of divinyl sulfone was added instead of 1 wt % of Compound 103.

### Preparation Example 2: 1.15M LiPF₆, PVS 0.3 Wt %+TPPa 0.3 Wt %

An electrolyte was prepared in the same manner as in Preparation Example 1, except that 0.3 wt % of Compound 105 was added instead of 1 wt % of Compound 103.

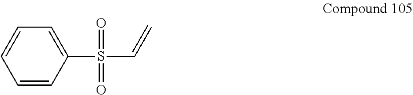

### Preparation Example 3: 1.15M LiPF₆, EVS 0.3 Wt %+TPPa 0.3 Wt %

An electrolyte was prepared in the same manner as in Preparation Example 1, except that 0.3 wt % of Compound 102 was added instead of 1 wt % of Compound 103.

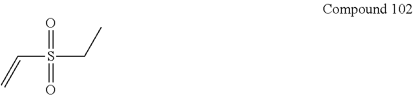

### Comparative Preparation Example 4: 1.15M LiPF₆, DPhs 0.3 Wt %+TPPa 0.3 Wt %

An electrolyte was prepared in the same manner as in Preparation Example 1, except that 0.3 wt % of diphenyl sulfone was added instead of 1 wt % of Compound 103.

### Preparation Example 4: 1.3M LiPF₆, AMS 0.3 Wt %+TPPa 0.5 Wt %

0.3 wt % of Compound 103 and 0.5 wt % of Compound 205, based on the total weight of an electrolyte, were added to an organic solvent in which 3 vol % of FEC, based on the total volume of the organic solvent, was mixed with EC/EMC/DMC (volume ratio 10:17:70), and 1.3M LiPF₆ was used as a lithium salt to prepare an electrolyte.

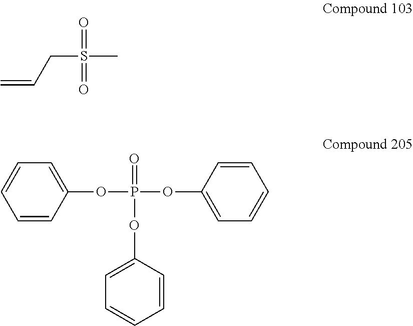

### Comparative Preparation Example 5: 1.3M LiPF₆, AMS+TPPa 0 Wt %

An electrolyte was prepared in the same manner as in Preparation Example 4, except that 0.3 wt % of Compound 103 and 0.5 wt % of Compound 205 were not added.

### Comparative Preparation Example 6: 1.3M LiPF₆, AMS 3 Wt %+TPPa 0.5 Wt %

An electrolyte was prepared in the same manner as in Preparation Example 4, except that 3 wt % of Compound 103 was added instead of 0.3 wt % of Compound 103.

### Comparative Preparation Example 7: 1.3M LiPF₆, AMS 0.3 Wt %+TPPa 5 Wt %

An electrolyte was prepared in the same manner as in Preparation Example 4, except that 5 wt % of Compound 205 was added instead of 0.5 wt % of Compound 205.

### Preparation Example 5: 1.3M LiPF₆, EVS 0.6 Wt %+TMP 2 Wt %

0.6 wt % of Compound 102 and 2 wt % of Compound 201, based on the total weight of an electrolyte, were added to an organic solvent in which 7 vol % of FEC, based on the total volume of the organic solvent, was mixed with EC/EMC/DMC (volume ratio 10:13:70), and 1.3M LiPF₆ was used as a lithium salt to prepare an electrolyte.

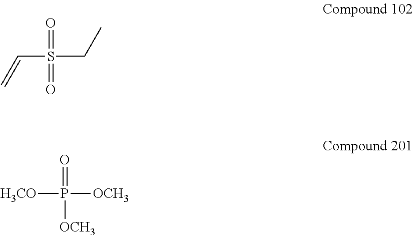

### Comparative Preparation Example 8: 1.3M LiPF₆, EVS+TMP 0 Wt %

An electrolyte was prepared in the same manner as in Preparation Example 5, except that 0.6 wt % of Compound 102 and 2 wt % of Compound 201 were not added.

### Comparative Preparation Example 9: 1.3M LiPF₆, TMP 2 Wt %

An electrolyte was prepared in the same manner as in Preparation Example 5, except that 0.6 wt % of Compound 102 was not added.

### Example 1

(Preparation of Cathode)

LiNi_{0.88}Co_{0.08}Mn_{0.04}O₂ as a cathode active material, carbon black as a conductive agent, and PVdF as a binder were mixed in a weight ratio of 97.7:1:1.3 to obtain a mixture, and the mixture was introduced into a N-methyl-2-pyrrolidone (NMP) solvent to a solid content of 70 wt %. The resulting mixture was stirred for 30 minutes using a mechanical stirrer to prepare a cathode active material composition. The cathode active material composition was applied onto both sides of an aluminum foil current collector having a thickness of 16 micrometers (μm) to a loading level of 37 milligrams per square centimeter (mg/cm²) using a 3-roll coater, dried at 100° C. for 0.5 hours using a hot drier, further dried in vacuum at 120° C. for 4 hours, and then roll-pressed to prepare a cathode provided with a cathode active material layer having a density of 3.6 grams per cubic centimeter (g/cc) on the current collector.

(Preparation of Anode)

15.7 wt % of a silicon carbon composite (SCN) and 80.3 wt % of graphite powder (G1/JPS, purity of 99.9% or more) as an anode active material were mixed with 4 wt % of an acrylic binder as a binder to obtain a mixture, and the mixture was introduced into a N-methyl-2-pyrrolidone (NMP) solvent to a solid content of 70 wt %. The resulting mixture was stirred for 60 minutes using a mechanical stirrer to prepare an anode active material composition. The anode active material composition was applied onto both sides of a copper foil current collector having a thickness of 10 μm to a loading level of 21.87 mg/cm² using a 3-roll coater, dried at 100° C. for 0.5 hours using a hot drier, further dried in vacuum at 120° C. for 4 hours, and then roll-pressed to prepare an anode provided with an anode active material layer having a density of 1.65 g/cc on the current collector.

(Assembly of Lithium Secondary Battery)

A 18650 cylindrical lithium secondary battery was manufactured using the prepared cathode, the prepared anode, a polyethylene separator, and the electrolyte prepared in Preparation Example 1.

### Examples 2 to 5

Lithium secondary batteries were manufactured in the same manner as in Example 1, except that the electrolytes prepared in Preparation Examples 2 to 5 were respectively used instead of the electrolyte prepared in Preparation Example 1.

### Comparative Examples 1 to 9

Lithium secondary batteries were manufactured in the same manner as in Example 1, except that the electrolytes prepared in Comparative Preparation Examples 1 to 9 were respectively used instead of the electrolyte prepared in Preparation Example 1.

### Evaluation Example 1: Evaluation of Capacity Retention Rate and Direct Current Internal Resistance Characteristics

(1) Evaluation of Charge-Discharge Characteristics at Room Temperature (25° C.)

Each of the lithium secondary batteries manufactured in Example 1 and Comparative Examples 1 and 2 was charged with a current of 0.2 C rate at 25° C. until a voltage reached 3.6 volts (V) (vs. Li/Li⁺), and then discharged at a constant current of 0.2 C until a voltage reached 2.8 V (vs. Li/Li⁺). Further, each of the lithium secondary batteries was charged with a current of 0.2 C rate until a voltage reached 4.25 V (vs. Li), and then discharged at a constant current of 0.2 C rate until a voltage reached 2.8 V (vs. Li) (first formation, 1^{st} and 2^{nd} cycles).

Each of the lithium secondary batteries having undergone the above first formation was charged with a current of 0.5 C rate at 25° C. until a voltage reached 4.25 V (vs. Li), and then cut off at a current of 0.05 C rate while maintaining 4.25 V of a voltage in a constant voltage mode. Then, each of the lithium secondary batteries was discharged at a constant current of 0.2 C rate until a voltage reached 2.8 V (vs. Li). This process was carried out for two cycles (second formation, 3^{rd} and 4^{th} cycles).

Each of the lithium secondary batteries having undergone the above second formation was charged with a current of 1 C rate at 25° C. until a voltage reached 4.25 V (vs. Li/Li⁺), and then cut off at a current of 0.05 C rate while maintaining 4.25 V of a voltage in a constant voltage mode. Then, each of the lithium secondary batteries was discharged at a constant current of 1.0 C rate until a voltage reached 2.8 V (vs. Li/Li⁺). These charge-discharge cycles were repeated 200 times.

A stop time of 20 minutes was provided after one charge-discharge cycle in the above charge-discharge cycles. Some of the results of the charge-discharge experiments are given in Table 1 below. The capacity retention in the n^{th} cycle was defined by Equation1 below.

Capacity retention rate=[discharge capacity at n^{th} cycle/discharge capacity at 1^{st} cycle]×100% Equation1

(2) Evaluation of Charge-Discharge Characteristics at High Temperature (45° C.)

The capacity retention rates of the lithium secondary batteries prepared in Example 4 and Comparative Examples 5 and 6 were evaluated by repeating charge-discharge cycles at 45° C. 200 times in the same manner as in the above item (1), and the evaluation results thereof are given in Table 1 below.

(3) Evaluation of Initial Direct Current Internal Resistance (DCIR)

With respect to the lithium secondary batteries prepared in Examples 2 to 5 and Comparative Examples 2 to 9, the DCIRs of the lithium secondary batteries at room temperature (25° C.), having under gone the formation processes in the same manner as in the above item (1), were measured by the following method.

After each of the lithium secondary batteries was charged with a current of 0.5 C to a voltage of 50% of state of charge (SOC) in the 1^{st} cycle, cut off at 0.02 C, stopped for 10 minutes, and then discharged at a constant current of 1.0 ampere (A) for 10 seconds. At this time, DCIRs were calculated from voltage drop values, and the results are listed in Table 1 below.

(4) Evaluation of DCIR Increase Rate at Room Temperature (25° C.)

With respect to the lithium secondary batteries prepared in Examples 1 to 4 and Comparative Examples 1, 2, and 4 to 6, the DCIRs of the lithium secondary batteries at room temperature (25° C.), having undergone the formation processes in the same manner as in the above item (1) and 200 times charge-discharge cycles, were measured in the same method as in the above item (3).

A direct current internal resistance increase rate is calculated by Equation 2 below.

DCIR increase rate [%]=[direct current internal resistance after 200^{th} charge-discharge cycle/direct current internal resistance after formation]×100% Equation2

TABLE 1

| | | initial | |
|---|---|---|---|
| | | direct current | direct current |
| | capacity | internal | internal |
| | retention | resistance | resistance |
| | rate | milliOhms | increase rate |
| | (%) | (mΩ) | (ΔDCIR) (%) |
| Example 1 | 77 | — | 123 |
| Comparative Example 1 | 76 | — | 123 |
| Comparative Example 2 | 72 | 124 | 129 |
| Comparative Example 3 | — | 147 | — |
| Example 2 | — | 166 | 120 |
| Example 3 | — | 158 | 122 |
| Comparative Example 4 | — | 167 | 119 |
| Example 4 | 82 | 117 | 126 |
| Comparative Example 5 | 82 | 114 | 129 |
| Comparative Example 6 | 73 | 126 | 134 |
| Comparative Example 7 | — | 128 | — |
| Example 5 | — | 147 | — |
| Comparative Example 8 | — | 147 | — |
| Comparative Example 9 | — | 146 | — |

As shown in Table 1 above, it was found that the lithium secondary battery of Example 1 exhibits good lifetime characteristics and high resistance suppressing characteristics as compared with the lithium secondary battery of Comparative Example 2.

In the lithium secondary battery of Comparative Example 2 with an electrolyte including a sulfone-based compound as an additive, capacity retention decreases, and a direct current internal resistance increases, as compared with the lithium secondary battery of Comparative Example 1 with an electrolyte not including a sulfone-based compound as an additive. In contrast, in the lithium secondary battery of Example 1, a capacity retention rate and a direct current internal resistance increase rate are maintained as compared with the lithium secondary battery of Comparative Example 1. That is, because the lithium secondary battery of Example 1 includes both a sulfone-based compound and a phosphate-based compound, resistance increase and lifetime deterioration are prevented.

Further, in the lithium secondary battery of Comparative Example 3 with an electrolyte including divinyl sulfone as an additive, an initial direct current resistance is relatively large, and thus stability is poor, as compared with the lithium secondary battery of Comparative Example 2. While not wanting to be bound by theory, it is understood that the likely reason can be based on a principle that an SEI film having high resistance is formed on the surface of an anode by divinyl sulfone during a formation process to increase the initial direct current internal resistance, whereas an SEI film having low resistance is formed on the surface of an anode by AMS does not increase the initial direct current internal resistance.

In the lithium secondary battery of Example 4, capacity retention greatly increases, and an initial direct current resistance and a rate of direct current resistance increase are relatively low, as compared with the lithium secondary battery of Comparative Example 6 with an electrolyte including 3 wt % of a sulfone-based compound. The reason can be based on a mechanism that a thick film is formed on the surface of an anode by an excessive amount of the sulfone compound included in the electrolyte of the lithium secondary battery of Comparative Example 6. However, the proposed stated mechanism does not in any way further limit the subject matter claimed.

In the lithium secondary battery of Example 4, an initial direct current resistance is low, as compared with the lithium secondary battery of Comparative Example 7 with an electrolyte including 5 wt % of a phosphate-based compound. Accordingly, the presence of the phosphate-based compound in the electrolyte in an amount of more than 5 wt %, exhibits a relatively high initial direct current resistance, which can lead to poor battery stability.

The initial direct current resistance of each of the lithium secondary batteries of Example 5 and Comparative Example 9 is substantially the same as that of the lithium secondary battery of Comparative Example 8 with an electrolyte not including a phosphate-based compound. That is, when the phosphate-base compound is included in the electrolyte of the lithium secondary in an amount of 5 wt % or less, it is possible to prevent or minimize an increase in an initial direct current resistance.

### Evaluation Example 2: Evaluation of Gas Generation Amount After Charge-Discharge Cycles

The lithium secondary batteries of Example 1 and Comparative Examples 1 and 2 having undergone 300 charge-discharge cycles and the lithium secondary batteries of Examples 2 to 4 and Comparative Examples 4 to 6 having undergone 200 charge-discharge cycles were put into a jig and torn out, and an internal gas pressure change was measured for each battery. Then, the internal gas pressure change was converted into a volume, to determine a corresponding amount of gas generation for each battery. The measured gas generation amount was divided by the weight of a cathode active material to determine the gas generation amount per weight of the cathode active material.

The evaluation results thereof are given in Table 2 below.

TABLE 2

| | Gas generation amount (mL/g) |
|---|---|
| Example 1 | 0.25 |
| Comparative Example 1 | 0.49 |
| Comparative Example 2 | 0.24 |
| Example 2 | 0.47 |
| Example 3 | 0.49 |
| Comparative Example 4 | 0.59 |
| Example 4 | 0.40 |
| Comparative Example 5 | 0.47 |
| Comparative Example 6 | 0.29 |

As shown in Table 2, the lithium secondary batteries of Example 1 and Comparative Example 2 each employing an electrolyte including a sulfone-based compound represented by Formula 1 as an additive, exhibit a decrease in the amount of gas generation, as compared with the lithium secondary battery of Comparative Example 1.

Further, it was found that, in the lithium secondary batteries of Example 2 and 3, an effect of reducing a gas generation is improved, as compared with the lithium secondary battery of Comparative Example 4, which employed an electrolyte including diphenyl sulfone. Further, it was found that, in the lithium secondary battery of Example 4 exhibits a reduction in gas generation, as compared with the lithium secondary battery of Comparative Example 5 employed an electrolyte not having the sulfone-based compound. While not wanting to be bound by theory, it is understood that these results are based on a mechanism that a stable protective film is formed on the surface of an anode by a sulfone-based compound including an unsaturated bond, and thus the generation of gas from decomposition of the solvent is suppressed.

Moreover, a comparison of the gas generation amount of the lithium secondary battery of Example 4 with the gas generation amount of the lithium secondary battery of Comparative Example 6, one observes that the generation of gas is further suppressed as the amount of a sulfone-based compound in the electrolyte increases. This result is inferred based on a mechanism that a thick film is formed on the surface of an anode as the amount of the sulfone-based compound is increased in the electrolyte. However, the proposed stated mechanism does not in any way further limit the subject matter claimed.

### Evaluation Example 3: Measurement of Storage Gas Generation Amount at High Temperature (60° C.)

The lithium secondary batteries manufactured in Example 4 and Comparative Examples 2, 3, 5, and 7 were subjected to the formation process of Evaluation Example 1, and then stored in an oven at 60° C. for 10 days. Then, the batteries were taken out from the oven and put into a jig and torn out, and an internal gas pressure change was measured. The internal gas pressure change was converted into a volume to determine a corresponding amount of gas generation for each battery. The measured gas generation amount was divided by the weight of a cathode active material to determine the gas generation amount per weight of the cathode active material. The evaluation results thereof are given in Table 3 below.

TABLE 3

| | Storage gas generation amount (mL/g) |
|---|---|
| Comparative Example 2 | 0.45 |
| Comparative Example 3 | 0.39 |
| Example 4 | 0.42 |
| Comparative Example 5 | 0.47 |
| Comparative Example 7 | 0.39 |

As shown in Table 3, the lithium secondary battery of Example 4, exhibits relatively less gas generation, as compared with the lithium secondary battery of Comparative Example 5 employing an electrolyte that does not include a sulfone-based compound.

### Evaluation Example 4: Measurement of Formation Gas Generation Amount

The lithium secondary batteries manufactured in Example 5 and Comparative Examples 8 and 9 were subjected to the above formation process as in Evaluation Example 1, and placed into a jig and torn out, and an internal gas pressure change was measured. Then, the internal gas pressure change was converted into a volume, and thus a gas generation amount was measured. The measured gas generation amount was divided by the weight of a cathode active material to determine the gas generation amount per weight of the cathode active material. Some of the evaluation results thereof are given in Table 4 below.

TABLE 4

| | Formation gas generation amount (mL/g) |
|---|---|
| Example 5 | 0.26 |
| Comparative Example 8 | 0.36 |
| Comparative Example 9 | 0.36 |

As shown in Table 4 above, the lithium secondary battery of Example 5, exhibits a relatively low amount of gas generation, as compared with the lithium secondary batteries of Comparative Examples 8 and 9 each employing an electrolyte that did not include a sulfone-based compound. This result suggests that during the process of charging the battery during the formation, a sulfone-based compound having a double bond is reduced prior to the solvent of the electrolyte to form a protective film on the surface of an anode, thereby suppressing the generation of gas. Again, the proposed stated mechanism does not in any way further limit the subject matter claimed.

### Evaluation Example 5

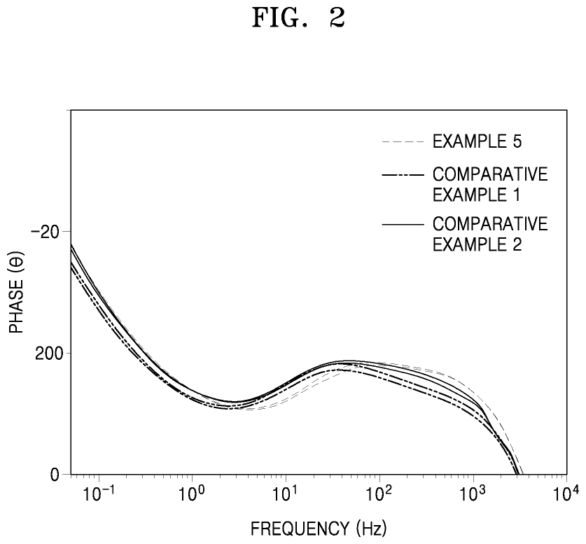

FIG. 2 is a graph showing a Bode plot illustrating the phase signals of the lithium secondary batteries manufactured in Example 1 and Comparative Examples 1 and 2 with respect to frequency bands. As shown in FIG. 2, at a frequency of about 10¹ to about 10² Hertz (Hz), the resistance of the lithium secondary battery of Example 1 is less than that of each of the lithium secondary batteries of Comparative Examples 1 and 2. That is, it was found that the anode film resistance of the lithium secondary battery of Example 1 is lower than that of each of the lithium batteries of Comparative Examples 1 and 2.

### Evaluation Example 6

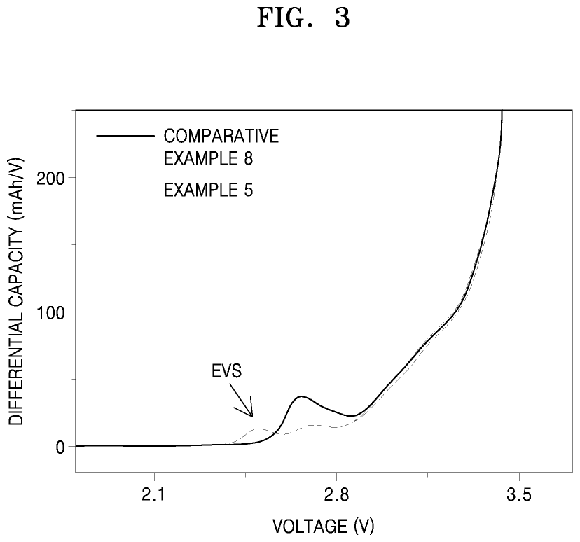

FIG. 3 is a graph illustrating differential capacity (dQ/dV) of the lithium secondary batteries manufactured in Example 5 and Comparative Example 8 with respect to a battery voltage of a first cycle. According to the graph of the dQ/dV curves, in the lithium secondary battery of Example 5, a peak is observed at about 2.5 V. This peak is determined to be a reduction peak of a sulfone-based compound including an unsaturated bond. This result suggests that the sulfone-based compound represented by Formula 1 is reduced during the formation process to form a protective film including sulfone on the surface of an anode, thereby suppressing the generation of hot gas. Again, the proposed stated mechanism does not in any way further limit the subject matter claimed.

According to embodiments, as the amount of nickel in the cathode active material increases the capacity of the lithium secondary battery is increased. Further, if the electrolyte includes a predetermined amount of a sulfone-based compound and a predetermined amount of a phosphate-based compound, the lithium secondary battery exhibits effects of suppressing a resistance increase, suppressing lifetime deterioration, and reducing gas generation.

It should be understood that embodiments described herein should be considered in a descriptive sense only and not for purposes of limitation. Descriptions of features or aspects within each embodiment should be considered as available for other similar features or aspects in other embodiments.

While an embodiment has been described with reference to the figures, it will be understood by those of ordinary skill in the art that various changes in form and details may be made therein without departing from the spirit and scope as defined by the following claims.

What is claimed is:

1. An electrolyte comprising:
a lithium salt;
an organic solvent;
a sulfone compound represented by Formula 1; and
a phosphate compound represented by Formula 2: 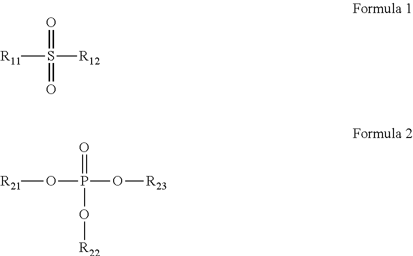
wherein, in Formulae 1 and 2,
R₁₁ and R₁₂ are each independently hydrogen, deuterium, a hydroxyl group, a substituted or unsubstituted C₁-C₆ alkyl group, a substituted or unsubstituted C₂-C₆ alkenyl group, a substituted or unsubstituted C₂-C₆ alkynyl group, a substituted or unsubstituted C₆-C₁₀ aryl group, or a substituted or unsubstituted C₁-C₁₀ heteroaryl group, and
at least one of R₁₁ or R₁₂ includes at least one unsaturated bond, and if one of R₁₁ or R₁₂ groups includes a vinyl group the other group does not include a vinyl group, and
R₂₁, R₂₂, and R₂₃ are each independently a substituted or unsubstituted C₁-C₆ alkyl group, a substituted or unsubstituted C₂-C₆ alkenyl group, a substituted or unsubstituted C₂-C₆ alkynyl group, a substituted or unsubstituted C₆-C₁₀ aryl group, or a substituted or unsubstituted C₁-C₁₀ heteroaryl group.

2. The electrolyte of claim 1,
wherein at least one of R₁₁ or R₁₂ is a vinyl group or an allyl group.

3. The electrolyte of claim 1,
wherein the sulfone compound is at least one of Compounds 101, 102, 103, 104, 105, 106, 107, 108, or 109

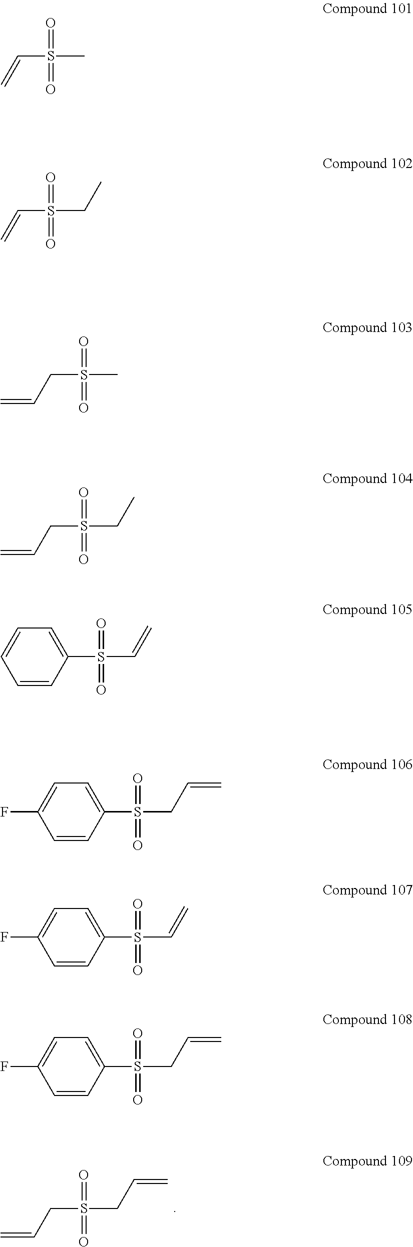

4. The electrolyte of claim 1,
wherein R₂₁, R₂₂, and R₂₃ are each independently a methyl group, an ethyl group, a propyl group, an isopropyl group, a butyl group, a sec-butyl group, a tert-butyl group, an isobutyl group, or a phenyl group; or
a methyl group, an ethyl group, a propyl group, an isopropyl group, a butyl group, a sec-butyl group, a tert-butyl group, an isobutyl group, or a phenyl group, each being substituted with at least one of deuterium, —F, —Cl, —Br, —I, a cyano group, a nitro group, a hydroxyl group, a methyl group, an ethyl group, or a propyl group.

5. The electrolyte of claim 1,
wherein the phosphate compound is at least one of Compounds 201, 202, 203, 204, 205, 206, 207, or 208

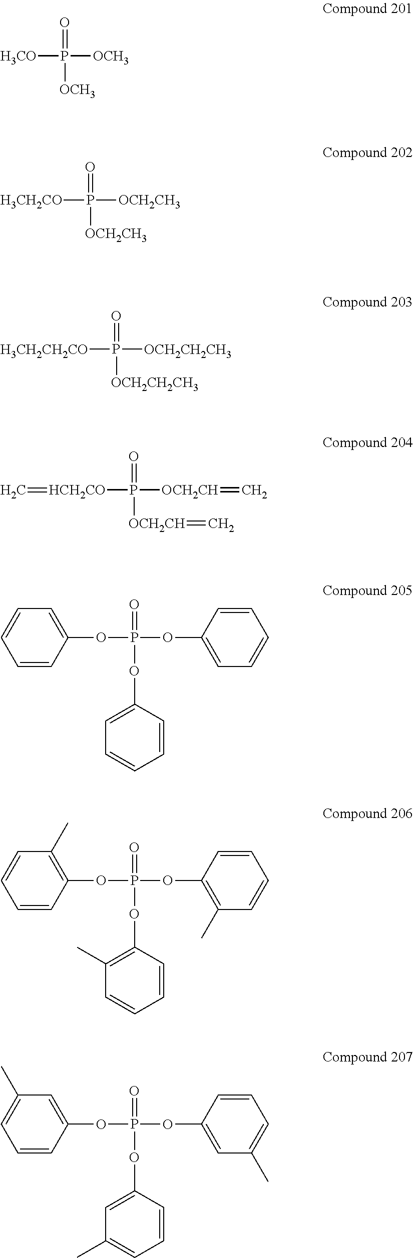

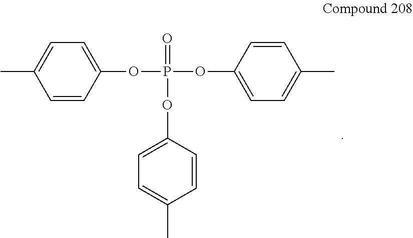

6. The electrolyte of claim 1,
wherein the sulfone compound is present in an amount of 0.1 weight percent to 3 weight percent, based on a total weight of the electrolyte.

7. The electrolyte of claim 1,
wherein the phosphate compound is present in an amount of 0.1 weight percent to 5 weight percent, based on a total weight of the electrolyte.

8. The electrolyte of claim 1,
wherein the organic solvent includes a cyclic carbonate compound represented by Formula 21 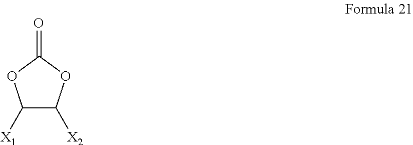
wherein Formula 21, X₁ and X₂ are each independently hydrogen or a halogen, and at least one of X₁ and X₂ is —F.

9. The electrolyte of claim 8,
wherein an amount of the cyclic carbonate compound represented by Formula 21 is present in about 0.1 volume percent to about 10 volume percent, based on a total volume of the organic solvent.

10. The electrolyte of claim 1,
wherein the electrolyte includes at least one of Compounds 101, 102, 103, 104, 105, 106, 107, 108 or 109 present in an amount of about 0.1 weight percent to about 3 weight percent, based on a total weight of the electrolyte, and includes at least one of Compounds 201, 201, 203, 204, 205, 206, 207, or 208 present in an amount of about 0.1 weight percent to about 5 weight percent, based on a total weight of the electrolyte, and the organic solvent includes fluoroethylene carbonate present in an amount of about 1 volume percent to about 10 volume percent, based on a total volume of the organic solvent

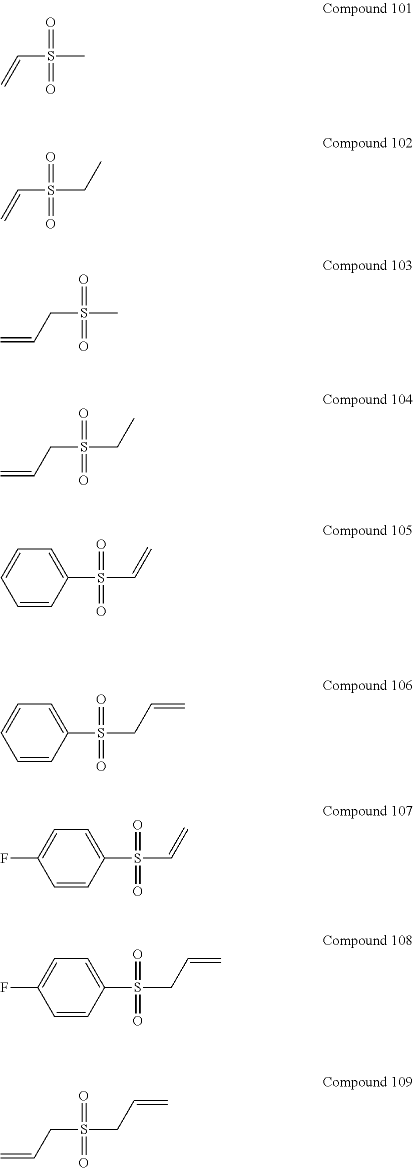

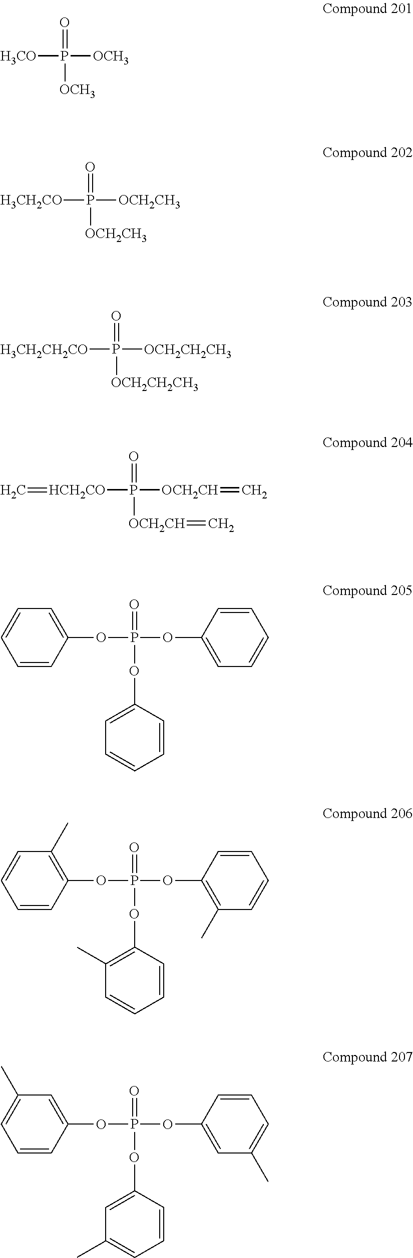

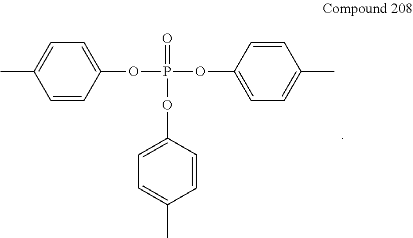

11. The electrolyte of claim 1,
wherein the lithium salt includes at least one of LiPF₆, LiBF₄, LiCF₃SO₃, Li(CF₃SO₂)₂N, LiC₂F₅SO₃, Li(FSO₂)₂N, LiC₄F₉SO₃, or LiN(SO₂CF₂CF₃)₂, or at least one compound represented by Formulae 22, 23, 24, or 25; or
the lithium salt includes at least one of LiPF₆, LiBF₄, LiCF₃SO₃, Li(CF₃SO₂)₂N, LiC₂F₅SO₃, Li(FSO₂)₂N, LiC₄F₉SO₃, or LiN(SO₂CF₂CF₃)₂, and at least one compound represented by Formulae 22, 23, 24, or 25

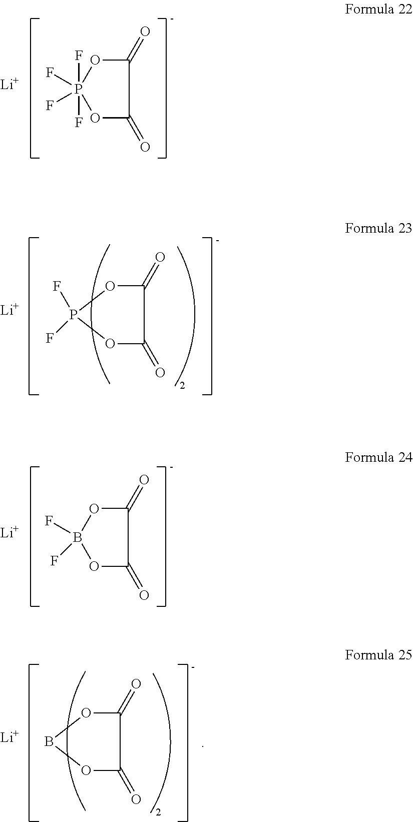

12. The electrolyte of claim 1,
wherein the organic solvent includes at least one of ethyl methyl carbonate, methyl propyl carbonate, ethyl propyl carbonate, dimethyl carbonate, diethyl carbonate), dipropyl carbonate, propylene carbonate, ethylene carbonate, fluoroethylene carbonate, vinylene carbonate, vinylethylene carbonate, or butylene carbonate.

13. A lithium secondary battery comprising:
a cathode;
an anode; and
the electrolyte of claim 1,
wherein the cathode includes a cathode active material represented by Formula
LiₓNi_{y}M_{1-y}O_{2-z}A_{z} Formula 3
in Formula 3,
0.9≤x≤1.2, 0.1≤y≤0.98, and 0≤z≤0.2 are satisfied, and
M is at least one of Al, Mg, Mn, Co, Fe, Cr, V, Ti, Cu, B, Ca, Zn, Zr, Nb, Mo, Sr, Sb, W, or Bi, and
A is an element having an oxidation number of −1, −2, or −3.

14. The lithium secondary battery of claim 13,
wherein, in Formula 3, 0.8≤y≤0.98 is satisfied.

15. The lithium secondary battery of claim 13,
wherein the cathode active material is represented by Formula 4:
Li_{x′}Ni_{y′}Co_{1-y′-z′}Mn_{z′}O₂ Formula 4
in Formula 4, 0.9≤x′≤1.2, 0.8≤y′≤0.98, 0<z′<0.1, and 0<1−y′−z′<0.2 are satisfied.

16. The lithium secondary battery of claim 13,
wherein the cathode active material includes LiNi_{0.88}Co_{0.08}Mn_{0.04}O₂, LiNi_{0.91}Co_{0.06}Mn_{0.03}O₂, Li_{1.02}Ni_{0.88}Co_{0.08}Mn_{0.04}O₂, or Li_{1.02}Ni_{0.91}Co_{0.06}Mn_{0.03}O₂.

17. The lithium secondary battery of claim 13,
wherein the anode includes an anode active material, and
the anode active material includes at least one of a silicon compound, a carbon compound, a composite of a silicon compound and a carbon compound, or a silicon oxide of the formula SiOₓ₁, wherein 0<x1<2.

18. The lithium secondary battery of claim 17,
wherein the silicon compound includes silicon particles, and
the silicon particles have an average particle diameter of about 10 nanometers to about 200 nanometers.

19. The lithium secondary battery of claim 13, further comprising
a protective film on a surface of the anode, wherein the protective film includes a sulfone.

20. The lithium secondary battery of claim 13,
wherein the lithium secondary battery has a cell energy density of about 500 Watt-hours per liter to 900 Watt-hours per liter per unit cell volume.
